(19) United States
(12) Patent Application Publication
(10) Pub. No.: US 2021/0020929 A1
(43) Pub. Date: Jan. 21, 2021

(54) SOLID-STATE ELECTRODES AND METHODS FOR MAKING THE SAME

(71) Applicant: GM GLOBAL TECHNOLOGY OPERATIONS LLC, Detroit, MI (US)

(72) Inventors: Dewen KONG, Shanghai (CN); Yong LU, Shanghai (CN); Mengyan HOU, Shanghai (CN); Zhe LI, Shanghai (CN); Haijing LIU, Shanghai (CN)

(73) Assignee: GM GLOBAL TECHNOLOGY OPERATIONS LLC, Detroit, MI (US)

(21) Appl. No.: 16/514,193

(22) Filed: Jul. 17, 2019

(51) Int. Cl. H01M 4/40; H01M 4/80; H01M 10/0525; H01M 4/62; H01M 4/66; H01M 4/505

(52) U.S. Cl. CPC H01M 4/405; H01M 4/80; H01M 10/0525; H01M 2004/024; H01M 4/661; H01M 4/663; H01M 4/505; H01M 4/622

(57) ABSTRACT

Solid-state electrodes and methods of forming solid-state electrodes and batteries are provided. The method includes contacting an electrode precursor with a liquid. The liquid includes one or more precursors of an ionically conductive polymer. The electrode precursor includes a plurality of electroactive particles and a plurality of electrolyte particles disposed on a current collector. A plurality of interparticle pores exists between the electroactive and electrolyte particles. When the electrode precursor is contacted with the liquid, the liquid flows into the interparticle pores. The one or more precursors of the ionically conductive polymer are electropolymerized so as to cause the formation of a polymeric matrix (including the ionically conductive polymer) that surrounds and embeds the plurality of electroactive particles and the plurality of electrolyte particles so as to form the solid-state electrode.

This section provides background information related to the present disclosure which is not necessarily prior art.

The present disclosure relates to solid-state electrodes including an ionically conductive polymeric matrix surrounding solid-state electroactive particles and solid-state electrolyte particles, and solid-state batteries including the solid-state electrodes, and methods of manufacturing (such as in-situ electropolymerization methods) related thereto.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. Lithium-ion batteries may also include various terminal and packaging materials. One of the two electrodes serves as a positive electrode or cathode and the other electrode serves as a negative electrode or anode. Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. A separator and/or electrolyte may be disposed between the negative and positive electrodes. The electrolyte, however, is suitable for conducting lithium ions between the electrodes and, like the two electrodes, may be in solid and/or liquid form and/or a hybrid thereof. In the instances of solid-state batteries, which include solid-state electrodes and a solid-state electrolyte, the solid-state electrolyte may physically separate the electrodes so that a distinct separator is not required.

Solid-state batteries offer several advantages, such as long shelf life with low self-discharge, operation with simple thermal management systems, and a reduced need for packaging. For example, solid-state electrolytes are generally non-volatile and non-flammable, so as to allow cells to be cycled under harsher conditions without experiencing diminished potential or thermal runaway, which can potentially occur with the use of liquid electrolytes. However, solid-state batteries generally experience comparatively low power capabilities. For example, such low power capabilities may be a result of interface resistance within the solid-state electrodes and/or at the electrode, electrolyte interface caused by limited contact, or void spaces, between the active particles and the solid-state electrolyte particles. Accordingly, it would be desirable to develop high-performance solid-state battery materials and methods that improve the contact and/or interaction between the active particles (e.g., the micro-interfaces) and the solid-electrolyte particles, the contact and/or interaction between the electrodes and solid-state electrolyte (e.g., the macro-interfaces), and/or mitigates the effects of the void spaces within the solid-state battery.

### SUMMARY

This section provides a general summary of the disclosure, and is not a comprehensive disclosure of its full scope or all of its features.

In various aspects, the present disclosure provides a method of manufacturing a solid-state electrode for a lithium-containing electrochemical cell. The method may include contacting a liquid including one or more precursors of an ionically conductive polymer with an electrode precursor. The electrode precursor may include a plurality of electroactive particles and a plurality of electrolyte particles disposed on a current collector. The electrode precursor may define a plurality of interparticle pores. The electrode precursor may have an interparticle porosity greater than or equal to about 1 vol. % to less than or equal to about 70 vol. %. When the electrode precursor is contacted with the liquid, the liquid may flow into the interparticle pores of the electrode precursor. The method may further include electropolymerizing the one or more precursors of the ionically conductive polymer. Electropolymerization may occur by applying a voltage between the metal current collector and a counter electrode so as to form a polymeric matrix that includes the ionically conductive polymer. The polymeric matrix (including the ionically conductive polymer) surrounds and embeds the plurality of electroactive particles and the plurality of electrolyte particles so as to form the solid-state electrode.

In one aspect, the one or more precursors of the ionically conductive polymer may include a monomer represented by a structure defined by:

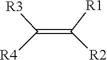

where R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted and unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙH₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations.

In one aspect, the electropolymerizing may include one or more of co-polymerization, crosslinking, and interpenetration and the ionically conductive polymer may be selected from the group consisting of: polyacrylonitrile (PAN), poly(methyl methacrylate) (PMMA), polyacrylic acid (PAA), and combinations thereof.

In one aspect, the liquid may further include one or more lithium salts. The lithium salts may be selected from the group consisting of: lithium iodide (LiI), lithium bis(trifluoromethanesulfonyl)imide (LiTFSI), lithium hexafluorophosphate (LiPF₆), lithium bis(oxalato)borate (LiBOB), lithium oxalydifluoroborate (LiODFB), lithium fluoroalkylphosphate (LiFAP), lithium hexafluoroarsenate (LiAsF₆), lithium tetrafluoroborate (LiBF₄), lithium perchlorate (LiClO₄), and combinations thereof.

In one aspect, the liquid may further include one or more solvents. The one or more solvents may be selected from the group consisting of: nitriles, furans, carbonates, and combinations thereof.

In one aspect the liquid may further include one or more additives. The one or more additives may be selected from the group consisting of: organic peroxides, azo compounds, metal iodides, metal alkyls, persulfates, and combinations thereof.

In one aspect, the electrode precursor maybe disposed onto an exposed surface of the counter electrode prior to the application of the voltage between the metal current collector and the counter electrode. An absolute voltage value applied may be greater than or equal to about 0.1 V, and a current applied during the electropolymerizing may be greater than or equal to about 1 pA at a temperature greater than or equal to about 0° C. to less than or equal to about 300° C.

In one aspect, the plurality of electroactive particles may be a first plurality of electroactive particles. The first plurality of electroactive particles may be disposed on a first surface of the current collector, and the electrode precursor may further include a second plurality of electroactive particles. The second plurality of electroactive particles may be disposed on a second surface of the current collector. The second surface of the current collector may oppose the first surface of the current collector. The first plurality of electroactive particles may be the same or different from the second plurality of electroactive particles.

In one aspect, the electrode precursor may further include a first plurality of electrolyte particles that may be mixed with the first plurality of electroactive particles and disposed on a first surface of the current collector; and a second plurality of electrolyte particles mixed that may be mixed with the second plurality of electroactive particles and disposed on a second surface of the current collector. The first plurality of electrolyte particles may be the same or different from the second plurality of electrolyte particles.

In one aspect, the electrode precursor may further include a plurality of electrolyte particles mixed with the plurality of electroactive particles. The electroactive particles may be selected from the group consisting of: LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiV₂(PO₄)₃, LiFeSiO₄, and combinations thereof. The electrolyte particles may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), Li₁₊ₓAlₓGe₂₋ₓ(PO₄)₃ (LAGP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), Li₁₀GeP₂S₁₂, Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), LiI, Li₅ZnI₄, Li₃OCl₁₋ₓBrₓ (where 0<x<1), Li₂B₄O₇, Li₂O(B₂O₃)(P₂O₅), LiPON, Li₃AlH₆, FeF₃, FeOF, and combinations thereof.

In one aspect, the electrode precursor may further include a plurality of electrolyte particles mixed with the plurality of electroactive particles. The electroactive particles may be selected from the group consisting of: Li₄Ti₅O₁₂, V₂O₅, FeS, and combinations thereof. The electrolyte particles may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), Li₁₊ₓAlₓGe₂₋ₓ(PO₄)₃ (LAGP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), Li₁₀GeP₂S₁₂, Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), LiI, Li₅ZnI₄, Li₃OCl₁₋ₓBrₓ (where 0<x<1), Li₂B₄O₇, Li₂O(B₂O₃)(P₂O₅), LiPON, Li₃AlH₆, FeF₃, FeOF, and combinations thereof.

In various other aspects, the present disclosure provides a method of manufacturing a solid-state battery. The method may include contacting a first liquid with a first electrode precursor. The first liquid may include one or more first precursors of a first ionically conductive polymer. The first electrode precursor may include a first plurality of electroactive particles and a first plurality of electrolyte particles disposed on a first side of a metal current collector. The first electrode precursor may define a first plurality of interparticle pores. The first electrode precursor may have a first interparticle porosity greater than or equal to about 1 vol. % to less than or equal to about 70 vol. %. When the first electrode precursor is contacted with the first liquid, the first liquid may flow into the first plurality of interparticle pores. The method may further include electropolymerizing the one or more first precursors of the first ionically conductive polymer. Electropolymerizing may include applying a voltage between the metal current collector and a counter electrode so as to form a first polymeric matrix. The first polymeric matrix includes the first ionically conductive polymer and surrounds and embeds the first plurality of electroactive particles and the first plurality of electrolyte particles. The method may further include contacting a second liquid with a second electrode precursor. The second liquid may include one or more second precursors of a second ionically conductive polymer. The second electrode may include a second plurality of electroactive particles and a second plurality of electrolyte particles disposed on a second side of the metal current collector. The second electrode may define a second plurality of interparticle pores. The second electrode may have a second interparticle porosity greater than or equal to about 1 vol. % to less than or equal to about 70 vol. %. When the second electrode is contacted with the second liquid, the second liquid may flow into the second plurality of interparticle pores. The method may further include electropolymerizing the one or more second precursors of the second ionically conductive polymer. Electropolymerizing may include applying a voltage between the metal current collector and a second counter electrode so as to form a second polymeric matrix. The second polymeric matrix includes the second ionically conductive polymer, which surrounds and embeds the second plurality of electroactive particles and the second plurality of electrolyte particles so as to form the solid-state battery, wherein the solid-state battery has an electrode porosity of less than or equal to about 15 vol. %.

In one aspect, the one or more first and second precursors of the first and second ionically conductive polymers each includes a monomer represented by a structure defined by:

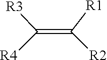

where R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted and unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙH₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations.

In one aspect, at least one of the first and second liquids may further include one or more lithium salts selected from the group consisting of: lithium iodide (LiI), lithium bis(trifluoromethanesulfonyl)imide (LiTFSI), lithium hexafluorophosphate (LiPF₆), lithium bis(oxalato)borate (LiBOB), lithium oxalydifluoroborate (LiODFB), lithium fluoroalkylphosphate (LiFAP), lithium hexafluoroarsenate (LiAsF₆), lithium tetrafluoroborate (LiBF₄), lithium perchlorate (LiClO₄), and combinations thereof.

In one aspect, at least one of the first and second liquids may further include one or more solvents selected from the group consisting of: nitriles, furans, carbonates, and combinations thereof.

In one aspect, at least one of the first and second liquids may further include one or more additives selected from the group consisting of: organic peroxides, azo compounds, metal iodides, metal alkyls, persulfates, and combinations thereof.

In one aspect, an absolute voltage value this is applied may be greater than or equal to about 0.1 V, and a current applied during the electropolymerizing may be greater than or equal to about 1 pA at a temperature greater than or equal to about 0° C. to less than or equal to about 300° C.

In various other aspects, the present disclosure provides a solid-state battery that may include a plurality of electroactive particles and a plurality of electrolyte particles that are embedded within a polymeric matrix. The polymeric matrix may have an ionically conductive polymer, and the solid-state battery may have an electrode porosity less than or equal to about 15 vol. %.

In one aspect, one or more precursors of the ionically conductive polymer includes a monomer represented by a structure defined by:

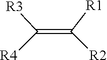

where R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted and unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙH₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations.

In one aspect, the battery may further include greater than or equal to about 0.1 wt. % to less than or equal to about 50 wt. % of one or more electrically conductive particles.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a solid-state electrochemical cell;

FIG. 2 is a schematic illustration of an electrode having an improved interparticle porosity in accordance with various aspects of the present disclosure;

FIGS. 3A-3B. FIG. 3A illustrates a first portion of a method for manufacturing a bi-polar electrode in accordance with various aspects of the present disclosure. FIG. 3B illustrates a second portion of the method of FIG. 3A; and

FIG. 4 illustrates a method for manufacturing a solid-state electrochemical cell in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth, such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers, and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology pertains to solid-state lithium-ion electrochemical cells that may be incorporated into energy storage devices like rechargeable lithium-batteries, which may be used in automotive applications. However, the present technology may also be used in other electrochemical devices, such as consumer electronic devices. In various aspects, the present disclosure provides a rechargeable lithium-ion battery that exhibits high temperature stability, as well as improved safety and superior power capability and excellent life performance.

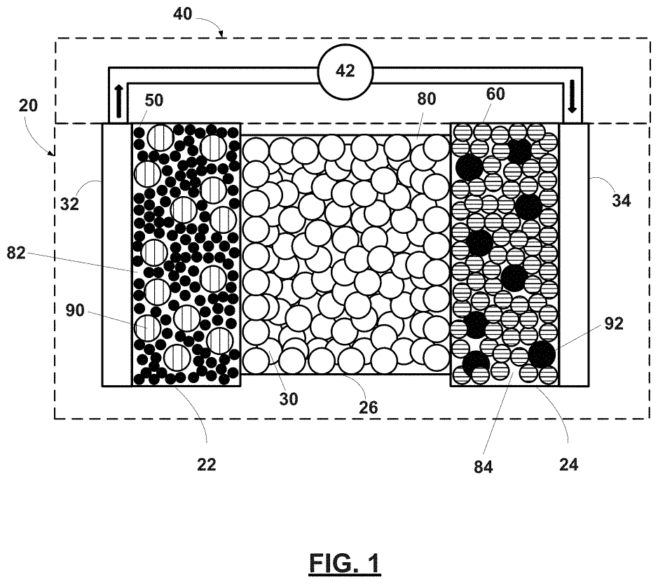

An exemplary and schematic illustration of an all-solid-state electrochemical cell (also referred to as the battery) that cycles lithium ions is shown in FIG. 1. The battery 20 includes a negative electrode 22, a positive electrode 24, and a separator 26 disposed between the electrodes 22, 24. In certain variations, the separator 26 may be formed by a solid-state electrolyte. For example, the separator 26 may be defined by a plurality of solid-state electrolyte particles 30. Pluralities of solid-state electrolyte particles 90, 92 may also be mixed with electroactive materials 50, 60 present in the negative electrode 22 and the positive electrode 24, respectively. A negative electrode current collector 32 may be positioned at or near the negative electrode 22, and a positive electrode current collector 34 may be positioned at or near the positive electrode 24. The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34).

The battery 20 can generate an electric current during discharge by way of reversible electrochemical reactions that occur when the external circuit 40 is closed (to connect the negative electrode 22 and the positive electrode 24) and the negative electrode 22 contains a relatively greater quantity of lithium. The chemical potential difference between the positive electrode 24 and the negative electrode 22 drives electrons produced by the oxidation of inserted lithium at the negative electrode 22 through the external circuit 40 towards the positive electrode 24. Lithium ions, which are also produced at the negative electrode 22, are concurrently transferred through the separator 26 towards the positive electrode 24. The electrons flow through the external circuit 40 and the lithium ions migrate across the separator 26 to the positive electrode 24, where they may be plated, reacted, or intercalated. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source (e.g., charging device) to the battery 20 to reverse the electrochemical reactions that occur during battery discharge. The connection of the external power source to the battery 20 compels the non-spontaneous oxidation of one or more metal elements at the positive electrode 24 to produce electrons and lithium ions. The electrons, which flow back towards the negative electrode 22 through the external circuit 40, and the lithium ions, which move across the separator 26 back towards the negative electrode 22, reunite at the negative electrode 22 and replenish it with lithium for consumption during the next battery discharge cycle. As such, each discharge and charge event is considered to be a cycle, where lithium ions are cycled between the positive electrode 24 and the negative electrode 22.

The external power source that may be used to charge the battery 20 may vary depending on size, construction, and particular end-use of the battery 20. Some notable and exemplary external power sources include, but are not limited to, AC power sources, such as an AC wall outlet and a motor vehicle alternator. In many battery 20 configurations, each of the negative electrode current collector 32, the negative electrode 22, the separator 26, the positive electrode 24, and the positive electrode current collector 34 are prepared as relatively thin layers (for example, from several microns to a millimeter or less in thickness) and assembled in layers connected in electrical parallel arrangement to provide a suitable electrical energy and power package. In various other instances, the battery 20 may include electrodes 22, 24 that are connected in series.

Further, in certain aspects, the battery 20 may include a variety of other components that, while not depicted here, are nonetheless known to those of skill in the art. For instance, the battery 20 may include a casing, gasket, terminal caps, and any other conventional components or materials that may be situated within the battery 20, including between or around the negative electrode 22, the positive electrode 24, and/or the separator 26, by way of non-limiting example. As noted above, the size and shape of the battery 20 may vary depending on the particular applications for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42.

Accordingly, the battery 20 can generate electric current to a load device 42 that can be operatively connected to the external circuit 40. The load device 42 may be powered fully or partially by the electric current passing through the external circuit 40 when the lithium ion battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be a power-generating apparatus that charges the battery 20 for purposes of storing energy.

With renewed reference to FIG. 1, the separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, as noted above, a first plurality of solid-state electrolyte particles 30 may define the separator 26. For example, the separator 26 may be in the form of a layer or a composite that comprises the first plurality of solid-state electrolyte particles 30. For example, as illustrated, the separator 26 may be in the form of a layer having a thickness greater than or equal to about 10 nm to less than or equal to about 1 mm, and in certain aspects, optionally greater than or equal to about 1 μm to less than or equal to about 100 μm. Such a separator 26 may have an interparticle porosity 80 between the first solid-state electrolyte particles 30 that is greater than or equal to about 1 vol. % to less than or equal to about 70 vol. %, optionally greater than or equal to 5 vol. % to less than or equal to about 40 vol. %, optionally greater than or equal to about 5 vol. % to less than or equal to about 30 vol. %, and in certain aspects, optionally greater than or equal to about 5 vol. % to less than or equal to about 20 vol. %.

The first plurality of solid state electrolyte particles 30 may comprise one or more of oxide-based particles, sulfide-based particles, halide-based particles, borate-based particles, nitride-based particles, hydride-based particles, and fluoride-based particles. In certain variations, the oxide-based particles may comprise one or more garnet ceramics, LISICON-type oxides, NASICON-type oxides, and Perovskite type ceramics. For example, the one or more garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, and combinations thereof. The one or more LISICON-type oxides may be selected from the group consisting of: Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The one or more NASICON-type oxides may be defined by LiMM′(PO₄)₃, where M and M′ are independently selected from Al, Ge, Ti, Sn, Hf, Zr, and La. For example, in certain variations, the one or more NASICON-type oxides may be selected from the group consisting of: Li₁₊ₓAlₓGe₂₋ₓ(PO₄)₃ (LAGP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The one or more Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the sulfide-based particles may include one or more sulfide-based materials selected from the group consisting of: Li₁₀GeP₂S₁₂, Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), and combinations thereof. The halide-based particles may include one or more halide-based materials selected from the group consisting of: LiI, Li₅ZnI₄, Li₃OCl₁₋ₓBrₓ (where 0<x<1), and combinations thereof. The borate-based particles may include one or more borate-based materials selected from the group consisting of Li₂B₄O₇, Li₂O(B₂O₃)(P₂O₅), and combinations thereof. The nitride-based particles may include LiPON. The hydride-based particles may include Li₃AlH₆. The fluoride-based particles may include one or more fluoride-based materials selected from the group consisting of: FeF₃, FeOF, and combinations thereof.

In this manner, in various aspects, the solid state electrolyte particles 30 may include one or more electrolyte materials selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), Li₁₊ₓAlₓGe₂₋ₓ(PO₄)₃ (LAGP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), Li₁₀GeP₂S₁₂, Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), LiI, Li₅ZnI₄, Li₃OCl₁₋ₓBrₓ (where 0<x<1), Li₂B₄O₇, Li₂O(B₂O₃)(P₂O₅), LiPON, Li₃AlH₆, FeF₃, FeOF, and combinations thereof. In certain variations, the solid state electrolyte particles 30 may include one or more electrolyte materials selected from the group consisting of: Li₇La₃Zr₂O₁₂ (LLZO), Li₁₄Zn(GeO₄)₄, Li₁₊ₓAlₓGe₂₋ₓ(PO₄)₃ (LAGP) (where 0≤x≤2), Li_{3.3}La_{0.53}TiO₃, Li₃xLa_{(2/3-x)}TiO₃ (where 0≤x≤0.25), LiI, Li₅ZnI₄, Li₃OCl₁₋ₓBrₓ (where 0<x<1), Li₂B₄O₇, Li₂O(B₂O₃)(P₂O₅), LiPON, Li₃AlH₆, FeF₃, FeOF, and combinations thereof.

In certain variations, the first solid-state electrolyte particles 30 may be optionally intermingled with one or more polymeric binders (not shown) and/or one or more reinforcing additives or fillers (also, not shown) that improve the structural integrity of the separator 26. The one or more binders may be selected from the group consisting of: polyvinylidene difluoride (PVdF), ethylene propylene diene monomer (EPDM) rubber, carboxymethoxyl cellulose (CMC), nitrile butadiene rubber (NBR), styrene-butadiene rubber (SBR), lithium polyacrylate (LiPAA), sodium polyacrylate (NaPAA), sodium alginate, lithium alginate, and combinations thereof. The one or more reinforcing additives or fillers may be selected from the group consisting of: silica-based glass fibers, alumina fibers, boron nitride fibers, thermoplastic polymer fibers, and combinations thereof. In certain variations, the separator 26 may include greater than or equal to about 0 wt. % to less than or equal to about 20 wt. % of the one or more binders and/or greater than or equal to about 0 wt. % to less than or equal to about 40 wt. % of the one or more reinforcing fillers.

The negative electrode may be formed from a lithium host material that is capable of functioning as a negative terminal of a lithium ion battery. For example, in certain variations, the negative electrode 22 may be defined by a plurality of negative solid-state electroactive particles 50. In certain instances, as illustrated, the negative electrode 22 is a composite comprising a mixture of the negative solid-state electroactive particles 50 and a second plurality of solid-state electrolyte particles 90. For example, the negative electrode 22 may include greater than or equal to about 10 wt. % to less than or equal to about 95 wt. %, and in certain aspects, optionally greater than or equal to about 50 wt. % to less than or equal to about 90 wt. % of the negative solid-state electroactive material 50; and greater than or equal to about 5 wt. % to less than or equal to about 90 wt. %, and in certain aspects, optionally greater than or equal to about 10 wt. % to less than or equal to about 40 wt. % of the second solid-state electrolyte particles 90. Such a negative electrode 22 may have an interparticle porosity 82 between the negative solid-state electroactive particles 50 and/or second solid-state electrolyte particles 90 that is greater than or equal to about 1 vol. % to less than or equal to about 70 vol. %, optionally greater than or equal to 3 vol. % to less than or equal to about 40 vol. %, optionally greater than or equal to about 10 vol. % to less than or equal to about 30 vol. %, and in certain aspects, optionally greater than or equal to about 15 vol. % to less than or equal to about 20 vol. %.

The second plurality of solid-state electrolyte particles 90 may be the same as or different from the first plurality of solid-state electrolyte particles 30. In certain variations, the second plurality of solid-state electrolyte particles 90 may comprise one or more electrolyte materials selected from the group consisting of: Li₇La₃Zr₂O₁₂ (LLZO), Li₁₄Zn(GeO₄)₄, Li₁₊ₓAlₓGe₂₋ₓ(PO₄)₃ (where 0≤x≤2), Li_{3.3}La_{0.53}TiO₃, Li₃ₓLa_{(2/3-x)}TiO₃ (where 0≤x≤0.25), LiI, Li₅ZnI₄, Li₃OCl, Li₂B₄O₇, Li₂O—B₂O₃—P₂O₅, LiPON, Li₃AlH₆, FeF₃, FeOF, and combinations thereof.

In certain variations, the negative solid-state electroactive particles 50 may be lithium based comprising, for example, a lithium metal and/or lithium alloy. In other variations, the negative solid-state electroactive particles 50 may be silicon based comprising, for example, a silicon alloy. In still other variations, the negative electrode 22 may be a carbonaceous anode and the negative solid-state electroactive particles 50 may comprise one or more negative electroactive materials such as graphite, graphene, and carbon nanotubes (CNTs). In still further variations, the negative electrode 22 may comprise one or more negative electroactive materials such as lithium titanium oxide (Li₄Ti₅O₁₂), one or more metal oxides such as V₂O₅, and metal sulfides such as FeS.

In certain variations, the negative solid-state electroactive particles 50 may be optionally intermingled with one or more electrically conductive materials that provide an electron conduction path and/or at least one polymeric binder material that improves the structural integrity of the negative electrode 22. For example, the negative solid-state electroactive particles 50 may be optionally intermingled with binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, and/or lithium alginate binders. Electrically conductive materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like. In certain variations, conductive additives may include one or more non-carbon conductive additives selected from simple oxides (such as RuO₂, SnO₂, ZnO, Ge₂O₃), superconductive oxides (such as YBa₂Cu₃O₇, La_{0.75}Ca_{0.25}MnO₃), carbides (such as SiC₂), silicides (such as MoSi₂), and sulfides (such as CoS₂).

In certain aspects, mixtures of the conductive materials may be used. For example, the negative electrode 22 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives; and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The negative electrode current collector 32 may be formed from copper (Cu) or any other appropriate electrically conductive material known to those of skill in the art.

The positive electrode 24 may be formed from a lithium-based electroactive material that can undergo lithium intercalation and deintercalation while functioning as the positive terminal of the battery 20. For example, in certain variations, the positive electrode 24 may be defined by a plurality of positive solid-state electroactive particles 60. In certain instances, as illustrated, the positive electrode 24 is a composite comprising a mixture of the positive solid-state electroactive particles 60 and a third plurality of solid-state electrolyte particles 92. For example, the positive electrode 24 may include greater than or equal to about 10 wt. % to less than or equal to about 95 wt. %, and in certain aspects, optionally greater than or equal to about 50 wt. % to less than or equal to about 90 wt. % of the positive solid-state electroactive material 60; and greater than or equal to about 5 wt. % to less than or equal to about 70 wt. %, and in certain aspects, optionally greater than or equal to about 10 wt. % to less than or equal to about 30 wt. % of the third solid-state electrolyte particles 92. Such a positive electrode 24 may have an interparticle porosity 84 between the positive solid-state electroactive particles 60 and/or third solid-state electrolyte particles 92 that is greater than or equal to about 1 vol. % to less than or equal to about 70 vol. %, optionally greater than or equal to 5 vol. % to less than or equal to about 40 vol. %, optionally greater than or equal to about 5 vol. % to less than or equal to about 30 vol. %, and in certain aspects, optionally greater than or equal to about 5 vol. % to less than or equal to about 20 vol. %.

In various instances, the third plurality of solid-state electrolyte particles 92 may be the same as or different from the first and/or second pluralities of solid-state electrolyte particles 30, 90. For example, the third plurality of solid-state electrolyte particles 92 may comprise one or more electrolyte materials selected from the group consisting of: Li₇La₃Zr₂O₁₂ (LLZO), Li₁₄Zn(GeO₄)₄, Li₁₊ₓAlₓGe₂₋ₓ(PO₄)₃ (where 0≤x≤2), Li_{3.3}La_{0.53}TiO₃, Li₃ₓLa_{(2/3-x)}TiO₃ (where 0≤x≤0.25), LiI, Li₅ZnI₄, Li₃OCl, Li₂B₄O₇, Li₂O—B₂O₃—P₂O₅, LiPON, Li₃AlH₆, FeF₃, FeOF, and combinations thereof.

In various aspects, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn₁₋ₓO₂ (where 0≤x≤1), and Li₁₊ₓMO₂ (where 0≤x≤1). The spinel cathode may include one or more positive electroactive materials such as LiMn₂O₄ and LiNiₓMn_{1.5}O₄. The polyanion cation may include for example a phosphate such as LiV₂(PO₄)₃ and/or a silicate such as LiFeSiO₄. In this fashion, in various aspects, the positive solid-state electroactive particles 60 may comprise one or more positive electroactive materials selected from the group consisting of: LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiV₂(PO₄)₃, LiFeSiO₄, and combinations thereof. In certain aspects, the positive solid-state electroactive particles 60 may be coated (for example by Al₂O₃) and/or the positive electroactive material may be doped (for example by magnesium (Mg)).

In certain variations, the positive solid-state electroactive particles 60 may be optionally intermingled with one or more electrically conductive materials that provide an electron conduction path and/or at least one polymeric binder material that improves the structural integrity of the positive electrode 24. For example, the positive solid-state electroactive particles 60 may be optionally intermingled with binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), lithium polyacrylate (LiPAA), sodium polyacrylate (NaPAA), sodium alginate, and/or lithium alginate binders. Electrically conductive materials may include carbon-based materials, powdered nickel or other metal particles, or a conductive polymer. Carbon-based materials may include, for example, particles of graphite, acetylene black (such as KETCHEN™ black or DENKA™ black), carbon fibers and nanotubes, graphene, and the like. Examples of a conductive polymer include polyaniline, polythiophene, polyacetylene, polypyrrole, and the like.

In certain aspects, mixtures of the conductive materials may be used. For example, the positive electrode 24 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives; and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The positive electrode current collector 34 may be formed from aluminum or any other electrically conductive material known to those of skill in the art.

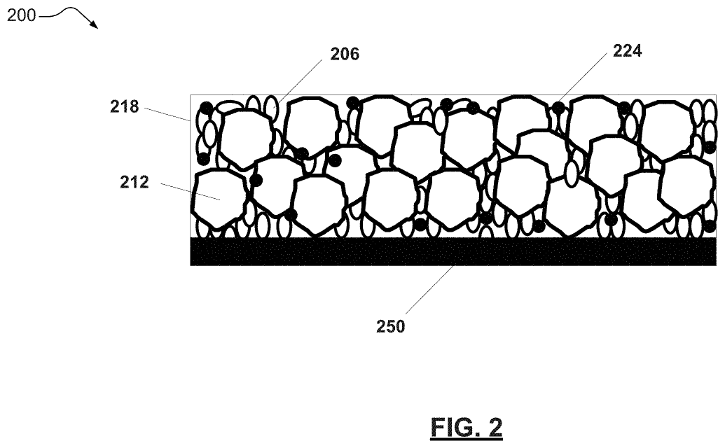

As a result of the interparticle porosity 80, 82, 84 between particles within the solid-state battery 20 (for example the solid-state battery 20 may have an interparticle porosity greater than or equal to about 1 vol. % to less than or equal to about 70 vol. %), direct contact between the solid-state electroactive particles 50, 60 and the solid-state electrolyte(s) 30, 90, 92 may be much lower than the contact between a liquid electrolyte and solid-state electroactive particles in comparable non-solid state batteries. To improve contact between the solid-state electroactive particles and solid-state electrolyte(s), the amount of the solid-state electrolyte(s) is often increased both within the electrodes and the separator. Such an increase results in comparatively thick layers, which together with the large quantity of solid-state electrolyte, results in low active material loading and low energy density and power. In various aspects, the present disclosure provides an alternative solid-state electrode configuration that has improved contact between the solid-state electroactive particles and the solid-state electrolyte. For example, FIG. 2 is an exemplary and schematic illustration of an electrode (for a lithium-containing electrochemical cell, such as battery 20) where the interparticle porosity is substantially eliminated or minimized.

In various aspects, the electrode 200 includes a polymeric matrix 218. For example, the electrode 200 may include a polymeric material matrix 218 comprising one or more lithium-ion conductive polymers such that the polymeric matrix 218 is an ionically conductive polymeric matrix. A plurality of particles may be distributed within the polymeric matrix 218. For example, in various aspects, a plurality of solid-state electrolyte particles 206 and a plurality of electroactive particles 212, such as those described above in the context of FIG. 1, may be distributed within the polymeric matrix 218. For example, the electrode 200 may include greater than or equal to about 1 wt. % to less than or equal to about 50 wt. % of the polymeric matrix 218 greater than or equal to about 1 wt. % to less than or equal to about 70 wt. % of the solid-state electrolyte particles 206 and greater than or equal to about 1 wt. % to less than or equal to about 70 wt. % of the the solid-state electroactive particles 212. In certain variations, a plurality of electrically conductive particles 224 may also be distributed within the polymeric matrix 218. For example, the electrode 200 may include greater than or equal to about 0 wt. % to less than or equal to about 25 wt. %, optionally greater than or equal to about 0 wt. % to less than or equal to about 20 wt. %, and in certain aspects, optionally greater than or equal to about 0 wt. % to less than or equal to about 5 wt. % of the one or more electrically conductive additives 224. The electrically conductive particles 224 are also described above in the context of FIG. 1.

The particles 206, 212, 224 may be homogeneously distributed within the polymeric matrix 218, while in other aspects, the particles 206, 212, 224 may be concentrated in certain regions. For example, in certain variations, the solid-state electrolyte particles 206 may be concentrated along a perimeter of the electrode 200. For example, the solid-state electrolyte particles 206 may form a dense region along a perimeter of the electrode 200. The dense region may be substantially free of solid-state electroactive particles 212. In each instance, the electrode 200 has an electrode porosity that is less than or equal to about 15 vol. %, optionally less than or equal to about 10 vol. %, optionally less than or equal to about 5 vol. %, optionally less than or equal to about 2 vol. %, optionally less than or equal to about 1 vol. %, and in certain aspects, less than or equal to about 0.5 vol. %. The electrode 200 may further include a current collector 250.

The polymeric matrix 218 encompasses the solid-state electrolyte particles 206 and the electroactive particles 212, and in certain aspects, the electrically conductive particles 224, and improves interface contact conditions within the electrode 200 such that interparticle porosity between the solid-state electrolyte particles 206 and/or the electroactive particles 212 and/or electrically conductive particles 224 is substantially small. For example, electrode 200 may have an electrode porosity less than or equal to about 15 vol. %, optionally less than or equal to about 10 vol. %, optionally less than or equal to about 5 vol. %, optionally less than or equal to about 2 vol. %, optionally less than or equal to about 1 vol. %, and in certain aspects, optionally less than or equal to about 0.5 vol. %. In this manner, the polymeric matrix 218 increases the available lithium ion transfer channels within the electrode so as to counteract deformation of the electroactive particles 212 and enhance performance of the solid-state battery.

In certain variations, the polymeric matrix 218 may comprise one or more ionically conductive polymers. The ionically conductive polymers may be selected from the group consisting of: polyacrylonitrile (PAN), poly(methyl methacrylate) (PMMA), polyacrylic acid (PAA), and combination thereof. In various aspects, one or more precursors of the ionically conductive polymer comprise a monomer represented by a structure defined by:

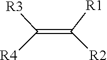

where R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted or unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙH₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations (such as —COOLi).

In various aspects, the present disclosure provides a method for manufacturing a solid-state electrode including an ionically conductive polymeric matrix that surrounds a plurality of solid-state electroactive particles and a plurality of solid-state electrolyte particles, such as the electrode 200 depicted in FIG. 2. The method includes contacting an electrode precursor with a liquid comprising one or more precursors of an ionically conductive polymer. In certain variations, the electrode precursor may be dipped into the liquid. The electrode precursor comprises a plurality of electroactive particles and a plurality of electrolyte particles. In certain variations, the electrode precursor may further include a plurality of electrically conductive particles, such as those described above in the context of FIG. 1. The electrode precursor may have an interparticle porosity that is greater than or equal to about 1 vol. % to less than or equal to about 70 vol. %, optionally greater than or equal to 5 vol. % to less than or equal to about 40 vol. %, optionally greater than or equal to about 5 vol. % to less than or equal to about 30 vol. %, and in certain aspects, optionally greater than or equal to about 5 vol. % to less than or equal to about 20 vol. %. The liquid flow into the interparticle pores of the electrode.

In various aspects, the one or more precursors of the ionically conductive polymer comprise a monomer represented by a structure defined by:

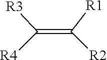

where R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted or unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙH₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations (such as —COOLi). For example, in certain instances, the monomers may be one or more of acrylonitrile, methyl methacrylate, and acrylate.

In various aspects, the liquid may further include one or more solvents. The one or more solvents may be selected from nitriles, furans, and carbonates. For example, in certain variations, the one or more solvents may be selected from the group consisting of acetonitrile, tetrahydrofuran, dimethyl carbonate (DMC), and combinations thereof. The one or more solvents may decrease the viscosity of the liquid so as to aid in establishing substantially uniform contact between the electroactive and electrolyte particles of the electrode precursor and the one or more precursors of the ionically conductive polymer. In further aspects, the liquid may further include one or more additives. The one or more additives may increase the rate of subsequent polymerization of the one or more polymeric precursors, for example electropolymerization as further detailed below. In certain variations, the one or more additives may be selected from organic peroxides, azo compounds, metal iodides, metal alkyls, and persulfates. In still further aspects, the liquid may include one or more lithium salts. The one or more lithium salts may enhance the ionic conductivity of the polymeric matrix. In certain variations, the one or more lithium salts may be selected from the group consisting of: lithium iodide (LiI), lithium bis(trifluoromethanesulfonyl)imide (LiTFSI), lithium hexafluorophosphate (LiPF₆), lithium bis(oxalato)borate (LiBOB), lithium oxalydifluoroborate (LiODFB), lithium fluoroalkylphosphate (LiFAP), lithium hexafluoroarsenate (LiAsF₆), lithium tetrafluoroborate (LiBF₄), lithium perchlorate (LiClO₄), and combinations thereof.

When the electrode precursor is contacted with the liquid, the liquid flows into the interparticle pores. In various aspects, the liquid may fill substantially all of the interparticle pores. For example, the liquid may fill greater than or equal to about 90 vol. %, optionally greater than or equal to about 95 vol. %, optionally greater than or equal to about 99 vol. %, and in certain aspects, optionally greater than or equal to about 99.5 vol. % of the interparticle pores of the electrode precursor. In certain variations, the electrode precursor may be a vacuum electrode so as to cause efficient influx of the liquid into the interparticle pores. In each instance, the solution-soaked electrode precursor may be placed in communication with a counter electrode. For example, the solution-soaked electrode precursor may be placed onto a surface of the counter electrode, which may form part of a fixture (e.g., a customized fixture) having a conductive element on which the electrode precursor may be placed.

A voltage may be applied across the solution-soaked electrode precursor so as to initiate or trigger electropolymerization of the one or more precursors of the ionically conductive polymers so as to form a polymeric matrix. The polymeric matrix comprises the ionically conductive polymer and that surrounds and embeds the plurality of electroactive particles and the plurality of electrolyte particles, and in certain aspects, optionally, the plurality of electrically conductive particles, so as to form the solid-state electrode. The absolute voltage value that is applied may be greater than or equal to about 0.1 V. For example, in certain variations, the absolute voltage value may be greater than or equal to about 0.1V to less than or equal to about 1000 V. In certain variations, during such electropolymerization the current may be held at greater than or equal to about 1 pA, and in certain aspects, optionally greater than or equal to about 1 pA to less than or equal to about 100 pA, and the temperature may be held at greater than or equal to about 0° C. to less than or equal to about 300° C., and in certain aspects, optionally greater than or equal to about 30° C. to less than or equal to about 300° C.

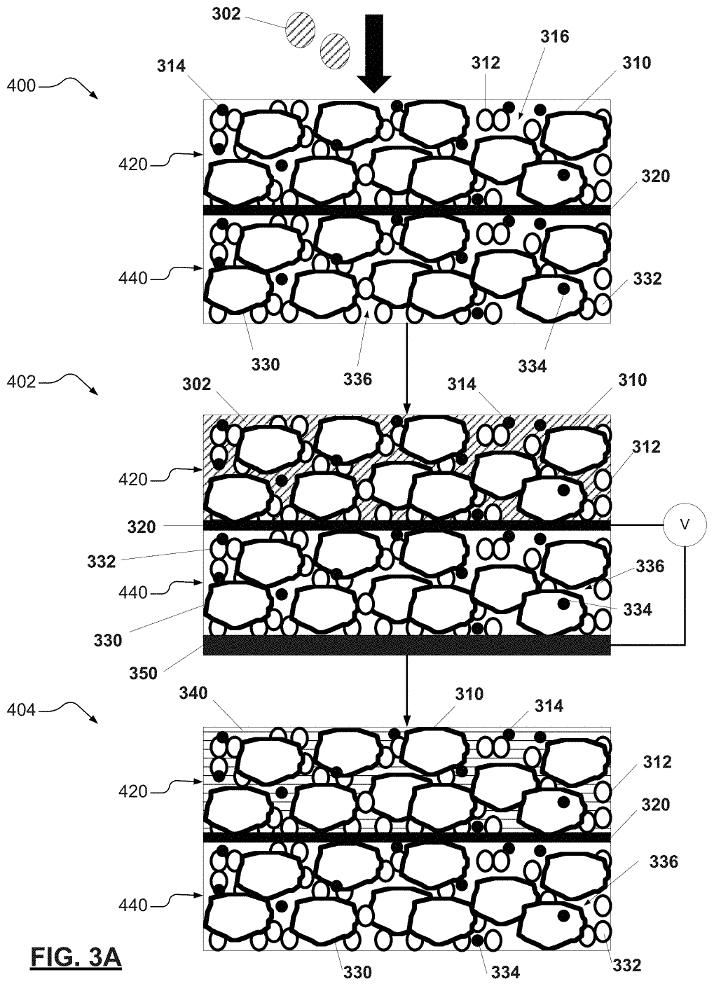

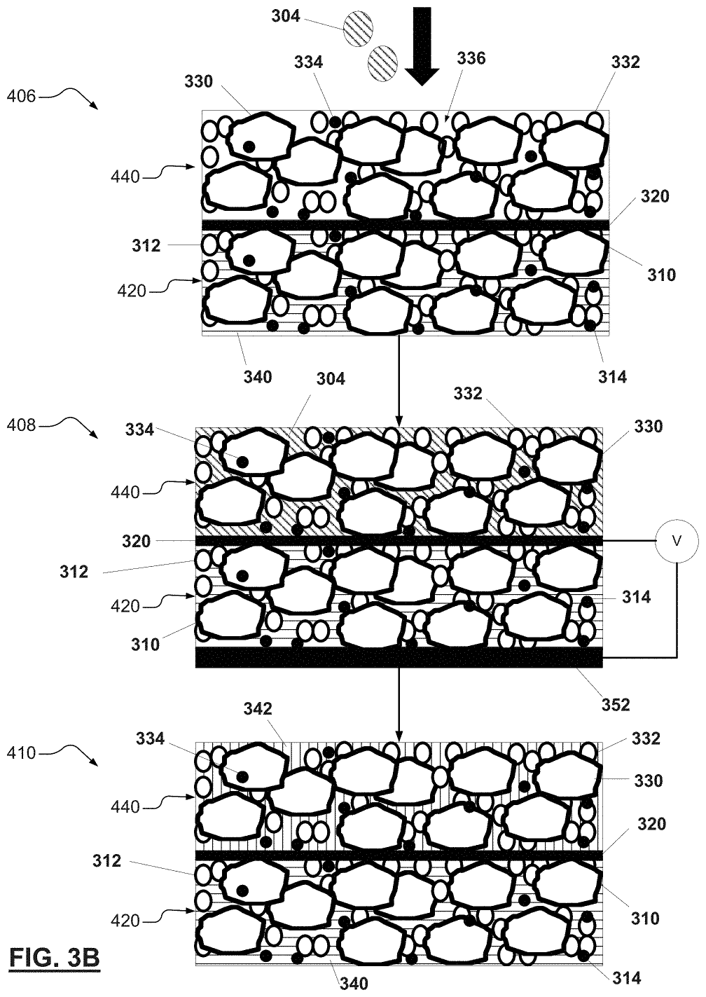

In various aspects, as depicted in FIGS. 3A-3B, the present disclosure provides a method for manufacturing a bi-polar solid-state electrode 300 comprising parallel electrodes 420, 440 and a current collector 320 disposed therebetween. Each electrode 420, 440 may be a solid-state electrode comprising a plurality of solid-state electroactive particles 310, 330; a plurality of solid-state electrolyte particles 312, 332; a plurality of solid-state electrically conductive particles 314, 334. In each instance, pores or voids 316, 336 exist between the solid-state particles. For example, the electrodes 420, 440 may each have an interparticle porosity 316, 336 that is greater than or equal to about 1 vol. % to less than or equal to about 70 vol. %, optionally greater than or equal to 5 vol. % to less than or equal to about 40 vol. %, optionally greater than or equal to about 5 vol. % to less than or equal to about 30 vol. %, and in certain aspects, optionally greater than or equal to about 5 vol. % to less than or equal to about 20 vol. %. The current collector 320 comprises one or more of aluminum (Al) and copper (Cu). In certain variations, the current collector may be an electronic conductive film, a carbon nanotube film, or a stainless steel foil.

The method generally includes contacting one of the solid-state electrodes 420, 440 with a liquid 302, 304 and placing the solution-soaked electrode in communication with a counter electrode 350, 352 and applying a voltage or establishing an electric current to initiate or trigger electropolymerization of the precursors of the liquid 402, 404. For example, at step 400, a first liquid 302, for example, as detailed above, is contacted with the first electrode 420. In certain variations, the first liquid 302 may be added to, for example dropped or poured, the first electrode 420. In other variations, the first electrode 420 may be dipped into a bath (for example, a monomer pool) comprising the first liquid 302. The skilled artisan will appreciate that there are a variety of means sufficient to achieve contact between the first liquid and the first electrode 420. When the first electrode 420 and the first liquid 302 are contacted, the first liquid 302 flows into the interparticle pores 316 of the first electrode. However, the first liquid 302 does not traverse the current collector 320.

At step 402, the liquid-soaked first electrode 420 may be placed in communication with a counter electrode 350. For example, the liquid-soaked first electrode 420 may be disposed onto a surface of the counter electrode. A voltage may be applied across the current collector 320 and the counter electrode 352 (or electrical current established) so as to initiate or trigger electropolymerization of the precursors present in the first liquid 302. For example, the absolute voltage value may be greater than or equal to about 0.1 V. In certain variations, the absolute voltage value may be greater than or equal to about 0.1 to less than or equal to about 1000 V. During such electropolymerization the current may be held at greater than or equal to about 1 pA, and in certain aspects, optionally greater than or equal to about 1 pA to less than or equal to about 1000 pA, and the temperature may be held at greater than or equal to about 0° C. to less than or equal to about 300° C., and in certain aspects, optionally greater than or equal to about 30° C. to less than or equal to about 300° C. Such polymerization of the precursors of the first liquid 302 results in the formation of the polymeric matrix 340, as seen at step 404. After the formation of the polymeric matrix 340, the first electrode 420 may have an electrode porosity less than or equal to about 10 vol. %, optionally less than or equal to about 5 vol. %, optionally less than or equal to about 2 vol. %, optionally less than or equal to about 1 vol. %, and in certain aspects, optionally less than or equal to about 0.5 vol. %.

At step 406, similar to step 400, a second liquid 304, for example, as detailed above, is contacted with the second electrode 440. The second liquid 304 flows into, and in certain variations, fills substantially all of the interparticle pores 336 of the second electrode 440l However, like the first liquid 302, the second liquid 304 does not traverse the current collector 320. At step 408, the solution-soaked second electrode 440 may be placed in communication with a counter electrode 352. For example, the solution-soaked second electrode 440 may be disposed onto a surface of the counter electrode. A voltage may be applied across the current collector 320 and the counter electrode 352 (or a current established) so as to initiate or trigger electropolymerization of the precursors of the second liquid 304. The voltage applied to the second electrode 440 and the sustained current and temperature may be the same as or different from that applied to the first electrode 420. For example, the absolute voltage value may be greater than or equal to about 0.1 V. In certain variations, the absolute voltage value may be greater than or equal to about 0.1V to less than or equal to about 1000 V. In certain variations, during such electropolymerization, the current may be held at greater than or equal to about 1 pA, and in certain aspects, optionally greater than or equal to about 1 pA to less than or equal to about 1000 pA, and the temperature may be held at greater than or equal to about 0° C. to less than or equal to about 300° C., and in certain aspects, optionally greater than or equal to about 0° C. to less than or equal to about 300° C. In each instance, however, such polymerization of the precursors of the second liquid 304 results in the formation of the polymeric matrix 342, as seen at step 410. After the formation of the polymeric matrix 340, the second electrode 440 may have an electrode porosity less than or equal to about 10 vol. %, optionally less than or equal to about 5 vol. %, optionally less than or equal to about 2 vol. %, optionally less than or equal to about 1 vol. %, and in certain aspects, optionally less than or equal to about 0.5 vol. %.

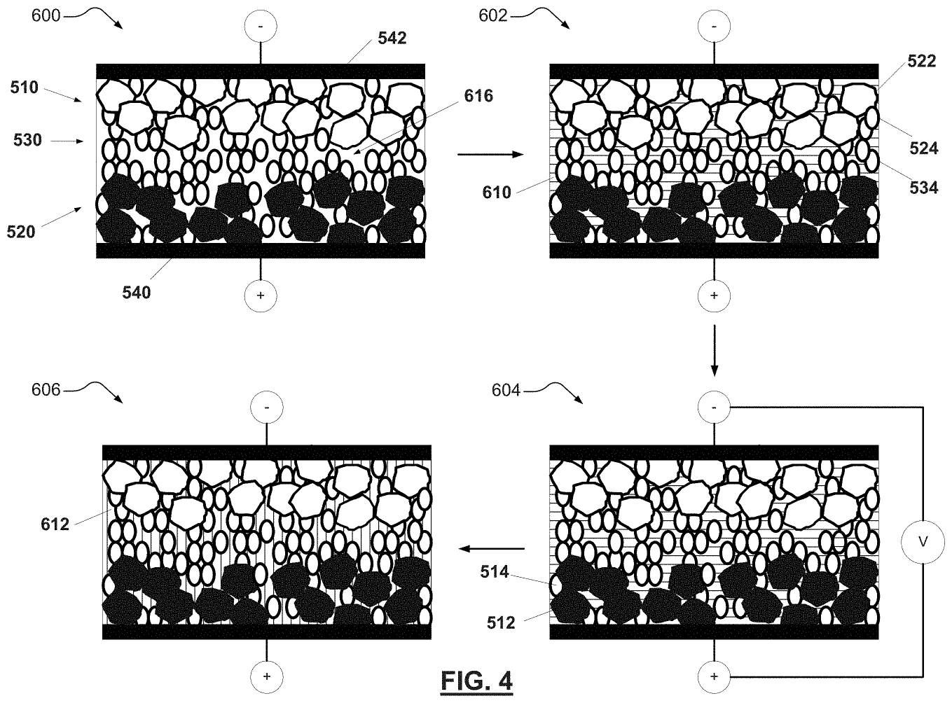

In various aspects, as depicted in FIG. 4, the present disclosure provides a method for manufacturing a solid-state electrochemical cell 500 in accordance with various aspects of the present disclosure. The solid-state electrochemical cell 500 comprises a positive electrode 510 and a negative electrode 520 and a separator 530 disposed therebetween. The positive electrode 510 is defined by a first plurality of solid-state electroactive particles 512 and a first plurality of solid-state electrolyte particles 514. The negative electrode 520 is likewise defined by a second plurality of solid-state electroactive particles 522 and a second plurality of electrolyte particles 524. The separator 530 is defined by a third plurality of electrolyte particles 534. In certain variations, the first and second, the first and third, the second and third, and/or first, second, and third electrolyte particles 514, 524, 534 may be the same or similar, as further detailed above. The electrode-separator-electrode is sandwiched by a pair of current collectors. A first current collector 540 is associated with the positive electrode 510 and may comprise, for example, aluminum. A second current collector 542 is associated with the negative electrode 520 and may comprise, for example, copper.

At step 600, the solid-state electrochemical cell 500 has a interparticle porosity 616 greater than or equal to about 1 vol. % to less than or equal to about 70 vol. %, optionally greater than or equal to 5 vol. % to less than or equal to about 40 vol. %, optionally greater than or equal to about 5 vol. % to less than or equal to about 30 vol. %, and in certain aspects, optionally greater than or equal to about 5 vol. % to less than or equal to about 20 vol. %. At step 602, the electrochemical cell 500 is contacted with a liquid 610, such as defined above. The liquid 610 flows into, and in certain variations, fills substantially all the interparticle pores 616. At step 604, communication between the positive current collector 540 and negative current collector 542 may be established and a voltage may be applied thereacross (or a current established) so as to initiate or trigger electropolymerization of the one or more precursors of the liquid 610. In certain variations, the absolute voltage value may be greater than or equal to about 0.1 V. For example, the absolute voltage value may be greater than or equal to about 0.1 V to less than or equal to about 1000 V. In certain variations, during such electropolymerization, the current may be held at greater than or equal to about 1 pA, and in certain aspects, optionally greater than or equal to about 1 pA to less than or equal to about 1000 pA, and the temperature may be held at greater than or equal to about 0° C. to less than or equal to about 300° C., and in certain aspects, optionally greater than or equal to about 30° C. to less than or equal to about 300° C. Such polymerization of the one or more precursors results in the formation of the polymeric matrix 612, as seen at step 606. After the formation of the polymeric matrix 612, the solid-state electrochemical cell 500 may have an electrode porosity less than or equal to about 10 vol. %, optionally less than or equal to about 5 vol. %, optionally less than or equal to about 2 vol. %, optionally less than or equal to about 1 vol. %, and in certain aspects, optionally less than or equal to about 0.5 vol. %.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of manufacturing a solid-state electrode for a lithium-containing electrochemical cell, the method comprising:
contacting a liquid comprising one or more precursors of an ionically conductive polymer with an electrode precursor comprising a plurality of electroactive particles disposed on a current collector, wherein the electrode precursor defines a plurality of interparticle pores having an interparticle porosity greater than or equal to about 1 vol. % to less than or equal to about 70 vol. % so that the liquid flows into the interparticle pores of the electrode precursor; and
electropolymerizing the one or more precursors of the ionically conductive polymer by applying a voltage between the metal current collector and a counter electrode so as to form a polymeric matrix comprising the ionically conductive polymer that surrounds and embeds the plurality of electroactive particles so as to form the solid-state electrode.

2. The method of claim 1, wherein the one or more precursors of the ionically conductive polymer comprise a monomer represented by a structure defined by: 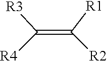
wherein R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted and unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙH₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations.

3. The method of claim 1, wherein the electropolymerizing includes one or more of co-polymerization, crosslinking, and interpenetration; and
wherein the ionically conductive polymer is selected from the group consisting of: polyacrylonitrile (PAN), poly(methyl methacrylate) (PMMA), polyacrylic acid (PAA), and combinations thereof.

4. The method of claim 1, wherein the liquid further comprises one or more lithium salts selected from the group consisting of: lithium iodide (LiI), lithium bis(trifluoromethanesulfonyl)imide (LiTFSI), lithium hexafluorophosphate (LiPF₆), lithium bis(oxalato)borate (LiBOB), lithium oxalydifluoroborate (LiODFB), lithium fluoroalkylphosphate (LiFAP), lithium hexafluoroarsenate (LiAsF₆), lithium tetrafluoroborate (LiBF₄), lithium perchlorate (LiClO₄), and combinations thereof.

5. The method of claim 1, wherein the liquid further comprises one or more solvents selected from the group consisting of: nitriles, furans, carbonates, and combinations thereof.

6. The method of claim 1, wherein the liquid further comprises one or more additives selected from the group consisting of: organic peroxides, azo compounds, metal iodides, metal alkyls, persulfates, and combinations thereof.

7. The method of claim 1, wherein the electrode precursor is disposed onto an exposed surface of the counter electrode prior to the application of the voltage between the metal current collector and the counter electrode;
wherein the applying the voltage applies an absolute voltage value of greater than or equal to about 0.1 V; and
wherein a current applied during the electropolymerizing is greater than or equal to about 1 pA at a temperature greater than or equal to about 0° C. to less than or equal to about 300° C.

8. The method of claim 1, wherein the plurality of electroactive particles is a first plurality of electroactive particles, and the first plurality of electroactive particles is disposed on a first surface of the current collector;
wherein the electrode precursor further comprises a second plurality of electroactive particles disposed on a second surface of the current collector, and the second surface of the current collector opposes the first surface of the current collector; and
wherein the first plurality of electroactive particles is the same or different from the second plurality of electroactive particles.

9. The method of claim 8, wherein the electrode precursor further comprises a first plurality of electrolyte particles mixed with the first plurality of electroactive particles and disposed on a first surface of the current collector, and a second plurality of electrolyte particles mixed with the second plurality of electroactive particles and disposed on a second surface of the current collector,
wherein the first plurality of electrolyte particles is the same or different from the second plurality of electrolyte particles.

10. The method of claim 1, wherein the electrode precursor further comprises a plurality of electrolyte particles mixed with the plurality of electroactive particles;
wherein the electroactive particles are selected from the group consisting of: LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiV₂(PO₄)₃, LiFeSiO₄, and combinations thereof; and
wherein the electrolyte particles are selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), Li₁₊ₓAlₓGe₂₋ₓ(PO₄)₃ (LAGP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), Li₁₀GeP₂S₁₂, Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), LiI, Li₅ZnI₄, Li₃OCl₁₋ₓBrₓ (where 0<x<1), Li₂B₄O₇, Li₂O(B₂O₃)(P₂O₅), LiPON, Li₃AlH₆, FeF₃, FeOF, and combinations thereof.

11. The method of claim 1, wherein the electrode precursor further comprises a plurality of electrolyte particles mixed with the plurality of electroactive particles;
wherein the electroactive particles are selected from the group consisting of: Li₄Ti₅O₁₂, V₂O₅, FeS, and combinations thereof; and
wherein the electrolyte particles are selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), Li₁₊ₓAlₓGe₂₋ₓ(PO₄)₃ (LAGP) (where 0≤x≤2), Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), Li₁₀GeP₂S₁₂, Li₆PS₅X (where X is Cl, Br, or I), Li₇P₂S₈I, Li_{10.35}Ge_{1.35}P_{1.65}S₁₂, Li_{3.25}Ge_{0.25}P_{0.75}S₄, Li₁₀SnP₂S₁₂, Li₁₀SiP₂S₁₂, Li_{9.54}Si_{1.74}P_{1.44}S_{11.7}Cl_{0.3}, (1−x)P₂S₅−xLi₂S (where 0.5≤x≤0.7), LiI, Li₅ZnI₄, Li₃OCl₁₋ₓBrₓ (where 0<x<1), Li₂B₄O₇, Li₂O(B₂O₃)(P₂O₅), LiPON, Li₃AlH₆, FeF₃, FeOF, and combinations thereof.

12. A method of manufacturing a solid-state battery, the method comprising:
contacting a first liquid comprising one or more first precursors of a first ionically conductive polymer with a first electrode precursor comprising a first plurality of electroactive particles and a first plurality of electrolyte particles disposed on a first side of a metal current collector, wherein the first electrode precursor defines a first plurality of interparticle pores having an interparticle porosity greater than or equal to about 1 vol. % to less than or equal to about 70 vol. % so that the first liquid flows into the first plurality of interparticle pores;
electropolymerizing the one or more first precursors of the first ionically conductive polymer by applying a voltage between the metal current collector and a first counter electrode so as to form a first polymeric matrix comprising the first ionically conductive polymer that surrounds and embeds the first plurality of electroactive particles and the first plurality of electrolyte particles;
contacting a second liquid comprising one or more second precursors of a second ionically conductive polymer with a second electrode precursor comprising a second plurality of electroactive particles and a second plurality of electrolyte particles disposed on a second side of the metal current collector, wherein the second electrode precursor defines a second plurality of interparticle pores having an interparticle porosity greater than or equal to about 1 vol. % to less than or equal to about 70 vol. % with so that the second liquid flows into the second plurality of interparticle pores; and
electropolymerizing the one or more second precursors of the second ionically conductive polymer by applying a voltage between the metal current collector and a second counter electrode so as to form a second polymeric matrix comprising the second ionically conductive polymer that surrounds and embeds the second plurality of electroactive particles and the second plurality of electrolyte particles so as to form the solid-state battery, wherein the solid-state battery has an electrode porosity of less than or equal to about 15 vol. %.

13. The method of claim 12, wherein the one or more first and second precursors of the first and second ionically conductive polymers each comprises a monomer represented by a structure defined by: 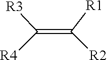
wherein R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted and unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙN₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations.

14. The method of claim 12, wherein at least one of the first and second liquids further comprises one or more lithium salts selected from the group consisting of: lithium iodide (LiI), lithium bis(trifluoromethanesulfonyl)imide (LiTFSI), lithium hexafluorophosphate (LiPF₆), lithium bis(oxalato)borate (LiBOB), lithium oxalydifluoroborate (LiODFB), lithium fluoroalkylphosphate (LiFAP), lithium hexafluoroarsenate (LiAsF₆), lithium tetrafluoroborate (LiBF₄), lithium perchlorate (LiClO₄), and combinations thereof.

15. The method of claim 12, wherein at least one of the first and second liquids further comprises one or more solvents selected from the group consisting of: nitriles, furans, carbonates, and combinations thereof.

16. The method of claim 12, wherein at least one of the first and second liquids further comprises one or more additives selected from the group consisting of: organic peroxides, azo compounds, metal iodides, metal alkyls, persulfates, and combinations thereof.

17. The method of claim 12, wherein the applying the voltage applies an absolute voltage value of greater than or equal to about 0.1 V; and
wherein a current applied during the electropolymerizing is greater than or equal to about 1 pA at a temperature greater than or equal to about 0° C. to less than or equal to about 300° C.

18. A solid-state battery comprising a plurality of electroactive particles and a plurality of electrolyte particles that are embedded within a polymeric matrix comprising an ionically conductive polymer, wherein the solid-state battery has an electrode porosity less than or equal to about 15 vol. %.

19. The solid-state battery of claim 18, wherein one or more precursors of the ionically conductive polymer comprises a monomer represented by a structure defined by: 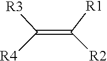
wherein R₁-R₄ are individually selected from linear or branched alkyls (—CₙH₂ₙ₊₁, where 1≤n≤20), linear or branched alkenes (—CₙH₂ₙ, where 1≤n≤20), linear or branched alkoxyls (—CₙH₂ₙ₊₁O, where 1≤n≤20), linear or branched ethers (—CₙH₂ₙ₊₁OCₘH₂ₘ, where 1≤n≤20 and where 1≤m≤10), substituted and unsubstituted phenyls (C₆H₅), mono-substituted phenyl (C₆H₅) having a linear or branched alkyls (—CₙH₂ₙ, where 1≤n≤20), di-substituted phenyl (C₆H₅) having a linear or branched alkyls (—CₙH₂ₙ, where 1≤n≤20), tri-substituted phenyl (C₆H₅) having a linear or branched alkyls (—CₙH₂ₙ, where 1≤n≤20), nitro (—NO₂), cyanogen (—C₂N₂), halogens, carboxyl (—COOH), and organic groups with one or more attached cations.

20. The solid-state battery of claim 18, wherein the battery further comprises greater than or equal to about 0.1 wt. % to less than or equal to about 50 wt. % of one or more electrically conductive particles.
